(19) United States
(12) Patent Application Publication
(10) Pub. No.: US 2018/0185867 A1
(43) Pub. Date: Jul. 5, 2018

(54) THERMAL SPRAYING METHOD

(71) Applicant: KS HUAYU ALUTECH GMBH, NECKARSULM (DE)

(72) Inventors: CHRISTIAN KLIMESCH, KARLSRUHE (DE); ANDREAS SCHALLER, BILLIGHEIM (DE); LEANDER SCHRAMM, REMDA-TEICHEL OT TEICHROEDA (DE); DIETER GEBERT, OEHRINGEN-VERRENBERG (DE)

(73) Assignee: KS HUAYU ALUTECH GMBH, NECKARSULM (DE)

(21) Appl. No.: 15/736,777

(22) PCT Filed: May 13, 2016
(86) PCT No.: PCT/EP2016/060880

§ 371 Date: Dec. 15, 2017

(30) Foreign Application Priority Data
Jun. 19, 2015 (DE) 10 2015 109 873.3

(51) Int. Cl. B05B 12/00; F02F 1/00; B05B 7/22; C23C 4/131

(52) U.S. Cl. CPC B05B 12/004; C23C 4/131; B05B 7/224; F02F 1/004

(57) ABSTRACT

A thermal spraying method for coating an inner surface of a cylinder of an internal combustion engine or a piston engine. The method includes applying a thermal spray layer to the inner surface of the cylinder via a spray jet which is emitted by a spray torch and which includes a spray material, optically monitoring, via an optical sensor device, surroundings of the spray jet as defined by a space outside the spray jet, and assuming a coating process to be defective if the optical sensor device detects one or more particles of the spray material supplied to the spray torch in the surroundings monitored outside the spray jet and a parameter of the one or more particles exceeds a defined threshold.

### CROSS REFERENCE TO PRIOR APPLICATIONS

This application is a U.S. National Phase application under 35 U.S.C. § 371 of International Application No. PCT/EP2016/060880, filed on May 13, 2016 and which claims benefit to German Patent Application No. 10 2015 109 873.3, filed on Jun. 19, 2015. The International Application was published in German on Dec. 22, 2016 as WO 2016/202511 A1 under PCT Article 21(2).

### FIELD

The present invention relates to a thermal spraying method for coating the inner surface of a cylinder of an internal combustion engine or a piston engine.

### BACKGROUND

Thermal spray torches have previously been described and are used for coating surfaces. For example, the PTWA (Plasma Transferred Wire Arc Spraying) or the RSW (Rotating Single Wire) methods are used in the automobile industry to coat the running surfaces of cylinder bores in internal combustion engines. For this purpose, a wire is fed to the spray torch by a feed device, the particles of the wire being sprayed onto the inner surface of the cylinders in a gas flow.

It is necessary to control the results of the method for achieving a consistent quality of the coating process. This is in particular the case since a subsequent honing process is very sensitive to irregularities that may be formed by the thermal coating process for a cylinder of an internal combustion engine or a piston engine. It is thus important to recognize a defective part and to rework the part if necessary.

The quality of the thermal spraying process has to date been controlled by a worker visually inspecting the coated cylinder running surface.

### SUMMARY

An aspect of the present invention is to provide a thermal spraying method for coating the inner surface of a cylinder of an internal combustion engine or a piston engine which allows for a simpler check of the result of the coating process.

In an embodiment, the present invention provides a thermal spraying method for coating an inner surface of a cylinder of an internal combustion engine or a piston engine. The method includes applying a thermal spray layer to the inner surface of the cylinder via a spray jet which is emitted by a spray torch and which comprises a spray material, optically monitoring, via an optical sensor device, surroundings of the spray jet as defined by a space outside the spray jet, and assuming a coating process to be defective if the optical sensor device detects one or more particles of the spray material supplied to the spray torch in the surroundings monitored outside the spray jet and a parameter of the one or more particles exceeds a defined threshold.

### BRIEF DESCRIPTION OF THE DRAWING

The present invention is described in greater detail below on the basis of embodiments and of the drawing in which:

FIG. 1 illustrates a cylinder of an internal combustion engine or a piston engine which is coated by a thermal spray torch.

### DETAILED DESCRIPTION

The thermal spraying method for coating the inner surface of a cylinder of an internal combustion engine or piston engine comprises the following method steps:

A thermal spray layer is applied onto the inner surface of the cylinder. This may be effected, for example, using the PTWA/RSW method known from the prior art.

According to the present invention, the surroundings of the spray jet is detected by an optical sensor device. The optical sensor device thus detects a space outside the spray jet. The coating process can be assumed to be defective if, in the region monitored by the optical sensor device, particles of the spray material fed to the spray torch are detected outside the spray jet.

Errors in the coating process can be detected in an automated manner by using an optical sensor device as provided by the present invention so that a control of the quality of the coating process by a human is no longer required. The defective part can then be reworked if necessary. The present invention provides that it is not the coated surface that is monitored directly, but the surroundings of the spray jet, i.e., a space outside the spray jet. If particles of the spray material exist outside the spray jet, the size and/or other parameters of which exceed a defined threshold, it is assumed that irregularities have occurred in the spray coating. It may happen, for example, that the wire fed to the spray torch as the spray material is not melting uniformly so that larger wire particles fly through the coating cabin outside the spray jet. Such particles can be detected by the optical sensor device of the present invention.

Such parameters as, for example, the size, frequency of occurrence, light intensity, velocity and/or trajectory of the spray material particles detected outside the spray jet can, for example, be monitored. If these parameters exceed defined thresholds, the coating process is assumed to be defective. The above parameters may be evaluated using software algorithms or filters so that a conclusion can be drawn on the quality of the coating process. It is possible, for example, to monitor the summed-up particle surface of all spray material particles detected outside the spray jet that can, for example, exceed a defined size. If this summed-up particle surface exceeds a defined limit value, the coating process may be assumed to be defective. It is also possible to monitor, for example, a profile of one of the above-mentioned values by establishing the mathematical derivation of this value. It is thereby possible, for example, to monitor the increase in particle surface, the increase in the frequency of occurrence of detected particles etc. If this derivation exceeds a defined threshold, the coating process may also be assumed to be defective.

It is also possible, for example, to use software algorithms to include the length of the sputters, the number of the sputters, their trajectory, or their size (for example, as a two-dimensional surface if only one camera is used). Derivations can also be established for these parameters so that, for example, an increase in surface is detected. If the detected gradient or derivation exceeds a defined threshold, the coating process may also be assumed to be defective.

The optical sensor device can, for example, monitor a region above the upper base surface of the cylinder, i.e., a region outside the cylinder, so as to detect particles of the spray material. If spray material particles, for example, glowing pieces of wire, fly out of the upper opening of the cylinder to be coated, these can be detected by the optical sensor device. A particularly simple structure of the device is possible due to the optical sensor device being arranged above the cylinder since the optical sensor device does not necessarily have to be introduced into the cylinder.

The optical sensor device can, for example, be a camera.

The optical sensor device can, for example, be a laser sensor.

The present invention also relates to a thermal spray torch for applying a thermal spray layer on the inner surface of a cylinder of an internal combustion engine or a piston engine. The device of the present invention may comprise all features described in the context of the method of the present invention, and vice versa.

The thermal spray torch of the present invention comprises an optical sensor device for the optical detection of the surroundings of the spray jet, i.e., of a space outside the spray jet. The device may, for example, be a camera or a laser sensor.

The optical sensor device can, for example, be oriented to a region above the upper base surface of the cylinder in order to detect spray material particles flying out of the upper opening of the cylinder.

An embodiment of the present invention will be described below under reference to the drawing.

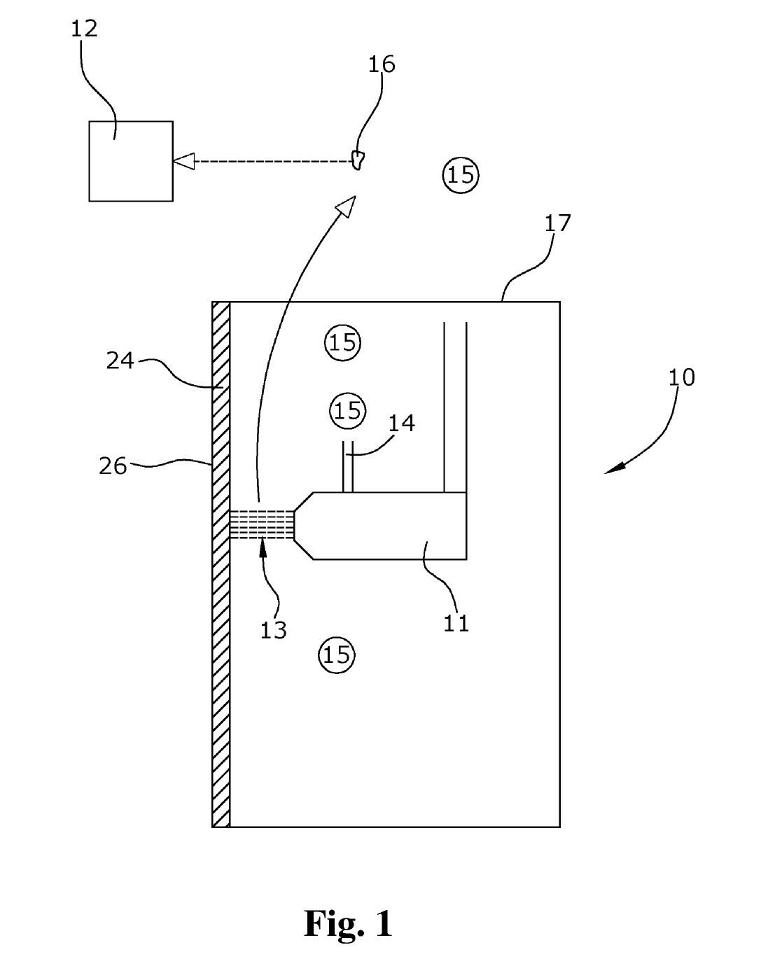

FIG. 1 illustrates a cylinder 10 of an internal combustion engine or a piston engine (which is not illustrated in the drawing), which cylinder 10 is coated by a thermal spray torch 11. For this purpose, a wire feeding device (which is not illustrated in the drawing) feeds a wire 14 to the thermal spray torch 11. The thermal spray torch 11 sprays the coating as a spray jet 13 onto the inner surface 26 of the cylinder 10 so that a coating 24 is applied thereon. According to the present invention, the optical sensor device 12 monitors a region 15 outside the spray jet 13 so as to detect particles of the spray material 14 outside the spray jet 13. These may, for example, be present above the upper base surface 17 of the cylinder 10 and may be detected by the optical sensor device 12, which can, for example, be a camera. If particles 16 are detected, the coating process may be assumed to be defective so that the part to be coated can be reworked.

The present invention is not limited to embodiments described herein; reference should be had to the appended claims.

What is claimed is:

1-7. (canceled)

8. A thermal spraying method for coating an inner surface of a cylinder of an internal combustion engine or a piston engine, the method comprising:
applying a thermal spray layer to the inner surface of the cylinder via a spray jet, the spray jet being emitted by a spray torch and comprising a spray material;
optically monitoring, via an optical sensor device, surroundings of the spray jet as defined by a space outside the spray jet; and
assuming a coating process to be defective if,
the optical sensor device detects one or more particles of the spray material supplied to the spray torch in the surroundings monitored outside the spray jet, and
a parameter of the one or more particles exceeds a defined threshold.

9. The thermal spraying method as recited in claim 8, wherein,
the parameter is at least one of a size, a frequency of occurrence, a light intensity, a velocity, a trajectory, and a length of the trajectory of the one or more particles of the spray material detected outside the spray jet, and
the coating process is assumed to be defective if the parameter or if a mathematical derivation or accumulation of the parameter exceeds the defined threshold.

10. The thermal spraying method as recited in claim 8, wherein the surroundings monitored by the optical sensor device is a region above an upper base surface of the cylinder outside the cylinder.

11. The thermal spraying method as recited in claim 8, wherein the optical sensor device is a camera.

12. The thermal spraying method as recited in claim 8, wherein the optical sensor device is a laser sensor.

13. A thermal spray torch for applying a thermal spray layer onto an inner surface of a cylinder of an internal combustion engine or of a piston engine via a spray jet which comprises a spray material, the thermal spray torch comprising:
an optical sensor device for optically detecting surroundings of the spray jet as defined by a space outside the spray jet.

14. The thermal spray torch as recited in claim 13, wherein the optical sensor device is oriented to a region above an upper base surface of the cylinder so as to detect one or more particles of the spray material outside the spray jet.
